(19) United States
(12) Patent Application Publication
(10) Pub. No.: US 2017/0206200 A1
(43) Pub. Date: Jul. 20, 2017

(54) DETERMINING ACTIVITIES RESPONSIVE TO PROFILE

(71) Applicant: Microsoft Technology Licensing, LLC, Redmond, WA (US)

(72) Inventors: Anurag Bajpai, Redmond, WA (US); Sriram Sivaraman, Bellevue, WA (US); Mukul Agarwal, Sammamish, WA (US); Rajan Verma, Redmond, WA (US); Sudhir G. Kulkarni, Sammamish, WA (US); Chandra Shekar Chilukuri, Bellevue, WA (US); Shabana Hashmi, Redmond, WA (US); Sachin Saki, Kirkland, WA (US); Ranga Das Gandla, Snoqualmie, WA (US)

(21) Appl. No.: 14/997,623

(22) Filed: Jan. 18, 2016

(51) Int. Cl. G06F 17/30; G06Q 10/10; H04L 29/08

(52) U.S. Cl. CPC G06F 17/3053; H04L 67/306; G06F 17/30864; G06F 17/3087; G06Q 10/1095

(57) ABSTRACT

An application, such as a personal assistant executed by a smart phone, determines that a user does not have any scheduled activities planned in their calendar for a period of time. Based on a profile of the user that describes user interests, the application determines multiple upcoming activities for the period of time that the user may enjoy. Using a ranking model that is based on user behavior as observed and collected by the application, the application selects one or more of the upcoming activities to recommend to the user. Based on whether or not the user accepts or rejects the recommended activities, the ranking model is updated using machine learning.

### BACKGROUND

Users have become increasingly reliant on electronic calendars to schedule the activities in their lives. Typically, users maintain multiple calendars, with each calendar including activities for a different aspect of the user's life. For example, a user may have a calendar for work, a social calendar, and a family calendar for family related activities.

Because of the use of multiple calendars, users may not easily recognize when they have upcoming unscheduled time (i.e., time not associated with an activity on any of the calendars) until the unscheduled time begins. This may force the user to either waste the unscheduled time, or to hastily search for activities to fill the unscheduled time leaving the user rushed and possibly unsatisfied. This may be exacerbated when the user is traveling or in an unfamiliar location, making locating suitable activities difficult.

### SUMMARY

An application, such as a personal assistant executed by a smart phone, determines that a user does not have any scheduled activities planned in their calendar for a period of time. Based on a profile of the user that describes user interests, the application determines multiple upcoming activities for the period of time that the user may enjoy. Using a ranking model that is based on user behavior as observed and collected by the application, the application selects one or more of the upcoming activities to recommend to the user. Based on whether or not the user accepts or rejects the recommended activities, the ranking model is updated using machine learning.

In an implementation, a request to identify one or more activities is received by a computing device. The request includes a user identifier, a start time, and an end time. A profile associated with the user identifier is received by the computing device. The profile includes a plurality of attributes. A plurality of activities that are responsive to the profile is determined based on the plurality of attributes of the profile and a plurality of attributes associated with each activity of the plurality of activities by the computing device. Each activity includes a start time and an end time that both occur within the start time and the end time of the request. The plurality of activities is ranked using a ranking model associated with the user identifier and the attributes associated with each activity of the plurality of activities by the computing device. A sequence of activities is selected from the plurality of activities based on the ranking by the computing device. The sequence of activities is ordered based on the end times and the start times associated with each activity in the sequence of activities. Graphical representations of the activities in the selected sequence of activities are displayed by the computing device

In an implementation, a profile associated with a user identifier is received by a computing device. Calendar data associated with the user identifier is received by the computing device. The calendar data identifies an activity history associated with the user identifier. Location data associated with the user is received by the computing device. The location data identifies a plurality of locations associated with the user identifier. Application data associated with the user is received by the computing device. The application data includes data from a plurality of applications associated with the user identifier. A ranking model is generated for the user identifier based on the profile, the calendar data, the location data, and the application data by the computing device. Identifiers of a plurality of activities are received by the computing device. The activities of the plurality of activities are ranked based on the ranking model by the computing device.

In an implementation, a system is provided. The system includes a computing device including a display, and an activity engine. The activity engine is configured to send a request to identify one or more activities to a search engine, wherein the request includes a user identifier, a start time, an end time, and a profile, wherein the profile is associated with a user identifier and comprises a plurality of attributes; receive a plurality of activities that are responsive to the profile based on the plurality of attributes of the profile and a plurality of attributes associated with each activity of the plurality of activities, wherein each activity includes a start time and an end time that occurs within the start time and the end time of the request; rank the plurality of activities using a ranking model associated with the user identifier and the attributes associated with the activities of the plurality of activities; select a sequence of activities from the plurality of activities based on the ranking, wherein the sequence of activities is ordered based on the end times and the start times associated with each activity; and provide graphical representations of the activities in the selected sequence of activities for display on the display associated with the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an implementation of an exemplary environment for recommending activities based on profiles;

FIG. 2 is an illustration of an implementation of an exemplary activity engine;

FIG. 3 is an illustration of an exemplary user interface for presenting graphical representations of activities to a user;

FIG. 4 is an illustration of an exemplary user interface for presenting graphical representations of activities to a user;

FIG. 5 is an illustration of an exemplary user interface for presenting graphical representations of activities to a user;

FIG. 6 is an operational flow of an implementation of a method for selecting and displaying graphical representations of a sequence of activities;

FIG. 7 is an operational flow of an implementation of a method for generating a ranking model and ranking a plurality of activities using the ranking model; and

FIG. 8 shows an exemplary computing environment in which example embodiments and aspects may be implemented.

### DETAILED DESCRIPTION

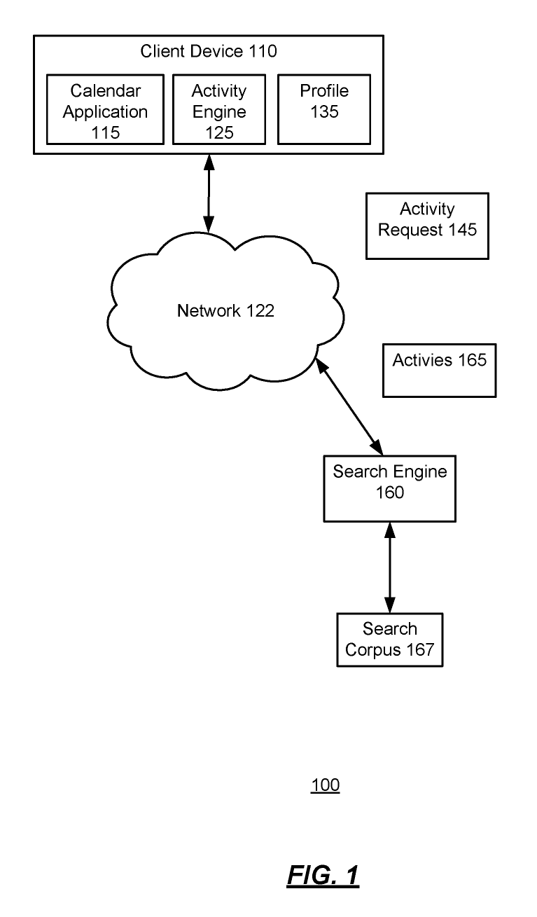

FIG. 1 is an illustration of an implementation of an exemplary environment 100 for recommending activities based on profiles. The environment 100 may include a search engine 160 and a client device 110 in communication through a network 122. The network 122 may be a variety of network types including the public switched telephone network (PSTN), a cellular telephone network, and a packet switched network (e.g., the Internet). Although only one search engine 160 and client device 110 are shown in FIG. 1, there is no limit to the number of search engines 160 and client devices 110 that may be supported.

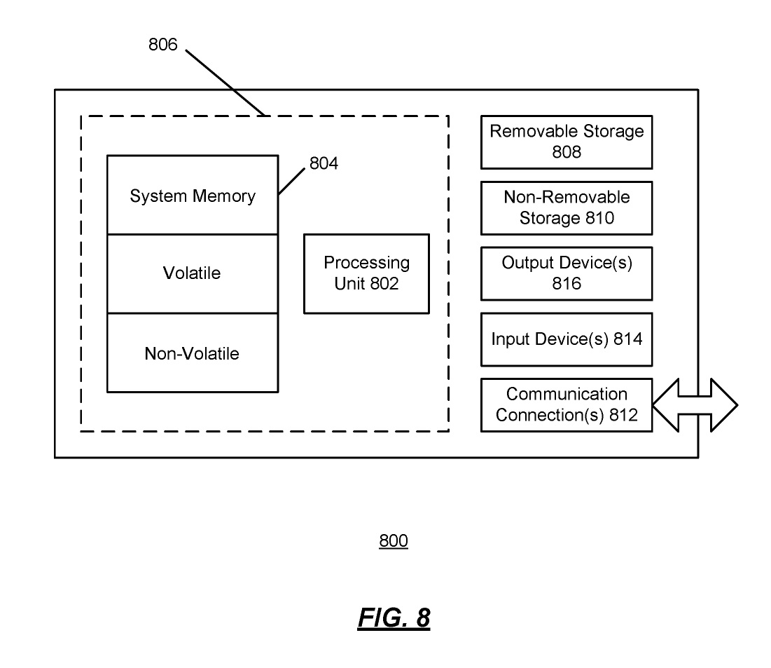

The search engine 160 and client device 110 may be implemented together or separately using a general purpose computing device such as the computing device 800 described with respect to FIG. 8. Example computing devices include a smart phone, a tablet computer, a laptop computer, a set-top box, a personal/digital video recorder, or any other type of computing device.

The client device 110 may execute one or more calendar applications 115. A calendar application 115 may be an application that allows a user to track and schedule one or more activities 165. Activities 165 may correspond to a variety of activities including, but not limited to, events, meetings, sporting activities, movies, concerts, meals (e.g., breakfast), restaurant reservations, tourist activities (e.g., site seeing), outdoor activities (e.g., hiking), traveling (e.g., hotel or airplane reservations), etc.

Each of the activities 165 in the calendar application 115 may have a start time that indicates when the activity may begin. The start time may be exact (e.g., 10:05) or may be approximate (e.g., around 10:00). In addition, each activity 165 may have an end time. Similar to the start time, the end time may be exact or approximate. In addition, some end times may be open ended. For example, an activity 165 such as dinner may not have a well-defined ending.

The activities 165 may further be associated with a location that indicates where the activity is taking place. For example, an activity 165 such as “go to the movies” may have a location that is the address of the movie theater, and an activity such as “attend meeting” may have a location that is the address of a workplace, or a name of a conference room where the meeting is scheduled. For some activities 165 like meetings described above, the location may be well defined, while for other activities 165 the location may be based on wherever a user associated with the activity 165 happens to be when the activity occurs. Examples of such activities 165 may be “brush teeth”, “call mom”, or “work on project.”

Users may maintain multiple calendars using the calendar application 115. For example, a user may maintain a work calendar where work related activities 165 such as meetings are kept, a social calendar where social activities 165 such as dinner reservations are kept, and a family calendar where family related activities 165 such as family trips or scheduled activities 165 for children are kept. Depending on the implementation, a single calendar application 115 may manage all of the calendars associated with a user, or a user may use a different calendar application 115 for some or all of their associated calendars.

A user of a client device 110 may be associated with a profile 135. The profile 135 associated with a user may include information that describes the various likes, dislikes, and interests of the user. For example, the profile 135 may identify the types of food, movies, television shows, restaurants, sports, and physical activities that are preferred by the user. Other information may be supported. The information about a user found in the profile 135 is referred to herein as attributes.

Depending on the implementation, the attributes of the profile 135 for a user may be provided by the user. For example, the user may be presented with a questionnaire or survey that asks the user to indicate their preferences with respect to food, entertainment, physical activity, etc.

Alternatively or additionally, the attributes of the profile 135 for user may be learned based on the behavior of the user. For example, based on information collected by the client device 110 about the user, the client device 110 may infer the likes and dislikes of the user. The collected information may include location information (e.g., GPS coordinates), information from the calendar application 115 about attended activities 165, and the particular content items (e.g., movies and television shows) that the user views on their client device 110.

In addition, the profile 135 may include general demographic information about the user. This information may include sex, age, education level, etc. Similarly, as described above, the demographic information may be provided by the user, or may be inferred by the client device 110.

Users may be asked to opt-in or otherwise consent to the creation of the profile 135 and/or the monitoring of the user behavior to create the profile 135. In addition, any information that may be used to uniquely identify the user may be removed from the profile 135 to protect the privacy of the user should the profile 135 be stolen or inadvertently made publicly available.

In order to help the user take advantage of unscheduled time (i.e., any time that is not accounted for in a calendar associated with the user), the client device 110 may further include an activity engine 125. The activity engine 125 may determine that the user has some amount of unscheduled time, and in response to the determination may generate an activity request 145. The activity request 145 may include an identifier of the user, and a start time and an end time associated with the unscheduled time. Depending on the implementation, the activity request 145 may also include some or all of the profile 135 associated with the user, and may include a location of where the user is likely to be during the unscheduled time.

In some implementations, the activity engine 125 may determine that the user has unscheduled time by comparing the various calendars associated with the user and determining time that is not scheduled on any of the calendars. In addition, the activity engine 125 may determine unscheduled time that is greater than a threshold amount of time such as two hours, three hours, four hours, etc. The threshold amount of time may be determined by the user associated with the client device 110.

In some implementations, the activity engine 125 may generate an activity request 145 in response to a user request or selection. For example, the activity engine 125 may highlight unscheduled time in the calendar application 115 and the user may click or select the unscheduled time to generate the activity request 145. Alternatively, or additionally, the user may ask the activity engine 125 to generate an activity request 145 for a specified time period. For example, the user may speak “determine activities for my upcoming weekend” into a voice interface associated with the activity engine 125, or may select an icon displayed by the activity engine 125 asking if the user would like some recommended activities for the upcoming weekend.

The activity engine 125 may be integrated into an application such as a personal assistant application. A personal assistant application is a type of application that can automatically perform one or more tasks for a user using information collected from a variety of online sources and offline sources. For example, a personal assistant application may retrieve a weather forecast when the user asks for the weather, or may find directions to a particular location when the user asks for directions. Using the functionality of the activity engine 125, the personal assistant application may be able to automatically identify activities 165 for the user with or without a user request.

In some implementations, the activity engine 125 may provide the activity request 145 to the search engine 160. The search engine 160 may be configured to identify multiple suitable activities 165 in response to received activity requests 145. In some implementations, the search engine 160 may fulfill the received activity requests 145 using activity data stored in a search corpus 167. The search corpus 167 may include information for a variety of activities 165 that have been collected from various sources across the Internet, such as newspapers, blogs, travel guides, etc. Each activity in the search corpus 167 may include information about the activity such as start time and end time (if applicable), a location associated with the activity, and other information that is descriptive of the activity and that can be used to determine if a user would like to participate in the activity. The information associated with an activity is referred to herein as activity attributes.

For example, for an activity 165 such as eating at a restaurant, the activity attributes may include the hours that the restaurant is opened, the cost of a typical meal associated with the restaurant, reviews of the restaurant, the address or the restaurant, the type of food associated with the restaurant, whether the restaurant is suitable for children, etc. For an activity 165 such as a festival, the activity attributes may include the events that are associated with the festival, the hours of the festival, the location of the festival, etc.

The search engine 160 may fulfill a received activity request 145 by searching the search corpus 167 for activities 165 that are likely to be responsive the activity request 145. For example, the search engine 160 may match the activity attributes of the activities 165 identified in the search corpus 167 with the attributes of the profile 135 included or identified by the activity request 145 to identify relevant activities 165. In addition, the relevant activities 165 may include activities with start and end times that occur within the start and end times included in the activity request 145, and activities that have a location that is close to the location of the user. The search engine 160 may provide the relevant activities 165 to the activity engine 125.

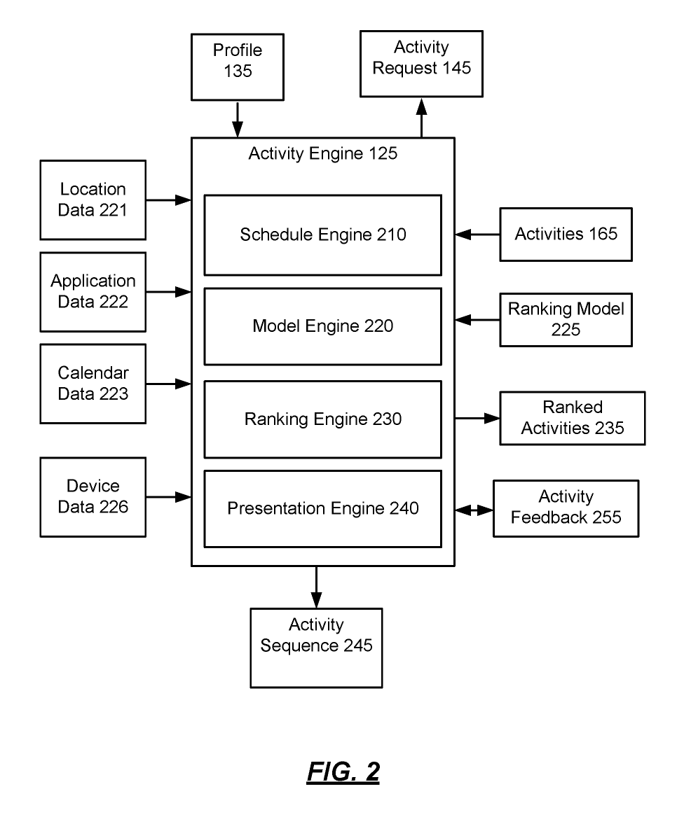

The activity engine 125 may present some or all of the activities 165 as suggested activities 165 for the particular unassigned times. For example, the activity engine 125 may display graphical representations of the activities 165 in the calendar application 115. Depending on the implementation, the user may accept or reject a proposed activity 165. As described further with respect to FIG. 2, whether or not the user accepts a proposed activity 165, and other information, may be used to rank or select the activities 165 that are ultimately recommended to the user from the activities 165 that are received from the search engine 160.

As may be appreciated, determining available time and recommending activities 165 to fill the available time has several advantages. First, because the available or unscheduled time is automatically identified ahead of the unscheduled time, the user is more likely to enjoy the time because they will have ample opportunity to select a suitable activity 165. Second, because suitable activities 165 are automatically identified and recommended to the user, the user is freed from selection fatigue or anxiety that may be associated with filling unscheduled time. Third, because the activities 165 are automatically identified, the user may be made aware of activities 165 that the user may not have considered, but that may be enjoyable for the user.

FIG. 2 is an illustration of an implementation of an exemplary activity engine 125. The activity engine 125 may include one or more components including a schedule engine 210, a model engine 220, a ranking engine 230, and a presentation engine 240. Some or all of the components of the activity engine 125 may be implemented by one or more computing devices such as the computing device 800 described with respect to FIG. 8.

The schedule engine 210 may generate an activity request 145. The activity request 145 may include a user identifier, a start time, and an end time. Depending on the implementation, the activity request 145 may include the profile 135 of the user, or the search engine 160 may be configured to retrieve the profile 135 using the user identifier.

The schedule engine 210 may generate the activity request 145 in response to determining that the user has an amount of unscheduled or available time that is greater than a threshold amount of time as indicated by calendar data 223. Unscheduled or available time may include any time that does not have an associated activity 165 in any of the calendars associated with the user.

Alternatively, or additionally, the schedule engine 210 may generate the request in response to a user selection or indication. For example, the user may request that the activity engine 125 determine activities 165 for Thursday afternoon from 1 pm to 6 pm, or the user may request that the activity engine 125 determine activities 165 for an entire upcoming weekend. In response, the schedule engine 210 may generate an activity request 145 with a start and end time that corresponds to the user request.

The activity request 145 may also include a location. The location may be the location where the user is scheduled to be located at during the times associated with the activity request 145. The location may be specified by the user, may be a default location associated with the user, or may be inferred based on calendar data 223 associated with the user. For example, the user may have a hotel reservation or airline reservation in their calendar that may indicate the location of the user at the times associated with the activity request 145. Other methods for determining or inferring a location may be used.

The schedule engine 210 may provide the generated activity request 145 to the search engine 160. The search engine 160 may provide the matching activities 165 in response to the activity request 145.

The model engine 220 may generate a ranking model 225 that may be used to rank and select activities 165 from the activities 165 that were received from the search engine 160. The ranking model 225 may be associated with a user, and may initially be generated for the user based on the attributes associated with the profile 135 using machine learning. The ranking model 225 may take as an input the attributes associated with a particular activity, and may output a score for the activity. The score may reflect the likelihood the user will select the activity and/or enjoy the activity.

The model engine 220 may continuously adjust the ranking model 225 based on additional information about the user determined by the client device 110. This information may include, but is not limited to, location data 221, application data 222, and calendar data 223. Other information may be considered. Depending on the implementation, the model engine 220 may consider the information determined by the client device 110 after the user affirmatively consents to the use of such information.

The location data 221 may include a history of locations associated with the user. The location data 221 may be used by the model engine 220 in combination with a map to infer the shops, restaurants, and other activities and activities that are frequented by the user. The location data 221 may be determined by a GPS (global positioning system) or other location component associated with the client device 110.

The application data 222 may include information determined from one or more applications associated with the client device 110 or user. Examples of applications may include word processing applications, social networking applications, web browser applications, and e-mail applications. For example, topics referenced in e-mails generated by the user using the e-mail application, or searched for by the user using the web browser application may indicate topics or activities that the user is interested in.

The calendar data 223 may include a history of activities 165 that the user previously attended or accepted, as well as a history of activities 165 that the user did not attend or declined. Because a user is likely to attend activities that they are interested in, and decline activities that they are not interested in, the calendar data 223 may be useful for ranking activities 165. In some implementations, the activities that are similar to activities that the user accepted in the past may be ranked higher than activities that are similar to activities that the user has not accepted, or declined, in the past.

When the activity engine 125 is integrated into a personal assistant application, the model engine 220 may adjust the ranking model 225 based on information collected by the personal assistant application. For example, information such as the particular reservations that the user asks the assistant to make, the searches that the user asks the assistant to perform, and the music that the user asks the assistant to play may be used to adjust the ranking model 225.

The ranking engine 230 may use the ranking model 225 to generate ranked activities 235 from the activities 165 received from the search engine 160 in response to the activity request 145. In some implementation, the ranking engine 230 may rank the activities 165 by generating a score for each of the activities 165 using the ranking model 225 and the activity attributes associated with the activity 165. The ranking engine 230 may rank the activities 165 based on the generated scores to generate the ranked activities 235.

The presentation engine 240 may generate one or more activity sequences 245 in response to the activity request 145. An activity sequence 245 may be an ordered, non-overlapping, sequence of activities 165 that begins at or around the start time associated with the activity request and ends at or around the end time associated with activity request 145.

The presentation engine 240 may select the activities for the activity sequence 245 from the ranked activities 235 by, starting with the start time of the activity request 145, selecting an activity from the ranked activities 235 with the highest rank that begins close to the start time of the activity request 145. The presentation engine 240 may continue sequentially selecting activities from the ranked activities 235 until all of the time associated with the activity request 145 has been accounted for.

Depending on the implementation, the presentation engine 240 may consider other information besides the ranking when selecting the activities 165 for the activity sequence 245, such as traffic or public transportation information, the locations of each activity in the ranked activities 235, and the weather. For example, when selecting an activity from the ranked activities 235, the presentation engine 240 may consult traffic information and/or public transit information associated with the location and times associated with each activity 165 of the ranked activities 235 and the most recently added activity 165 to the activity sequence 245 to ensure that there is ample time for the user to travel from the location of the most recently added activity 165 to the location of a selected activity 165. Thus, the presentation engine 240 may not select the activity 165 with the highest rank if there is not enough time to travel to the activity 165, or if attending the activity 165 would result in excessive travel time.

Similarly, the presentation engine 245 may also consider the weather forecast when selecting activities 165 from the ranked activities 235. For example, if the weather forecast is for rain, the presentation engine 240 may not select activities 165 that are outdoor activities, even where those activities 165 have the highest rank of the ranked activities 235.

The presentation engine 245 may also consider user preferences when selecting activities 165 for the activity sequence 245. For example, a user may prefer that the activity sequence 245 favor longer or shorter activities 165 when selecting activities 165 for the activity sequence 245. In another example, the user may prefer to minimize travel between activities 165, or may prefer to have meals at certain times.

The presentation engine 245 may further consider existing activities 165 in the calendars associated with the user when selecting activities for the activity sequence 245. For example, if an activity 165 is already scheduled for a time during the activity sequence 245, the presentation engine 240 may either add the scheduled activity 165 to the activity sequence 245, or may leave time corresponding to the scheduled activity 165 unscheduled in the event sequence 245.

The presentation engine 240 may present the generated one or more activity sequences 245 to the user at the client device 110. The one or more activity sequences 245 may be displayed to the user by the calendar application 115. For example, the calendar application 115 may display a graphical representation of each activity 165 in the one or more activity sequences 245. Each activity may be displayed to the user with information about the activity 165 such as the start and end time of the activity 165, reviews of the activity, and a description of the activity 165. Other information about each activity 165 may be displayed such as an image or video associated with the activity 165 and a link to a website where the user can get additional information about the activity 165.

Depending on the implementation, the manner in which the one or more activity sequences 245 are presented to the user may depend on device data 226. The device data 226 may describe the features and capabilities of the particular client device 110 associated with the user. Examples of device data 226 may include information on the type of client device 110 (e.g., smart phone, laptop, tablet, or desktop computer) and the capabilities of the client device 110 (e.g., memory, screen resolution, or processor speed). Other information may be supported.

For example, if the device data 226 indicates that the client device 110 is a smart phone, because of the limited display size, only one activity sequence 245 may be displayed to the user, and the graphical representations of each activity 165 in the activity sequence 245 may be displayed with minimal descriptive information. Similarly, if the device data 226 indicates that the client device 110 is a desktop computer, because of the larger display size, multiple activity sequences 245 may be displayed to the user, and the graphical representations of each activity 165 in each activity sequence 245 may be displayed with a maximum amount of details including images and videos about the activity 165.

In some implementations, for an activity sequence 245, the user may accept or reject the entire activity sequence 245, or may accept or reject individual activities 165 of the activity sequence 245. For example, the user may provide an indication of an acceptance or a rejection with respect to an activity sequence 245 by touching or selecting an associated user interface element. If the user accepts an activity sequence 245, or a particular activity 165 of the activity sequence 245, then the accepted activity sequence 245 or the selected activity 165 is added to a calendar associated with the user. In the user rejects an activity sequence 245, or a particular activity 165 of the activity sequence 245, then the presentation engine 240 may provide a new activity sequence 245, or a new activity 165 to replace the rejected activity 165.

The presentation engine 240 may further generate activity feedback 255. The activity feedback 255 may comprise information about the activities 165 that were accepted or rejected by the user. In some implementations, the model engine 220 may use the activity feedback 255 to adjust the ranking model 225.

In some implementations, the activity engine 125 may dynamically adjust the particular activities in an activity sequence 245 based on additional information even after the activities have been accepted by the user. For example, if the weather changes unexpectedly to rain, or there is an unexpected activity such as a traffic accident, then the activity engine 125 may select new activities 165 that are not outdoors, or that avoid the location associated with the traffic accident.

Similarly, the activity engine 125 may dynamically adjust the particular activities 165 in an activity sequence 245 based on real-time information associated with the user. For example, if the user is late to a particular activity 165, skips an activity 165, or remains at an activity 165 longer or shorter than scheduled, the activity engine 125 may make any adjustments to the timing of remaining activities 165 in the activity sequence 245, including adding or removing activities 165. The location of the user may be dynamically determined by a location determination component associated with the client device 110, for example.

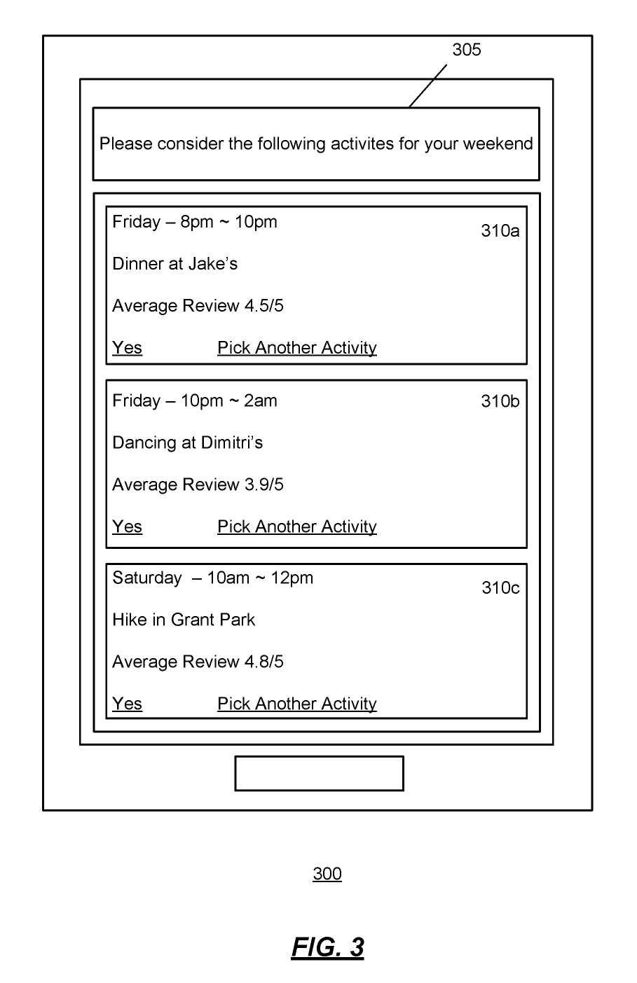

FIG. 3 is an illustration of an exemplary user interface 300 for presenting graphical representations of activities 165 to a user. As shown, the user interface 300 may be implemented on client device 110 such a smart phone.

The user interface 300 displays a portion of an activity sequence 245 corresponding to an activity request 145 for activities 165 for a weekend. In the example shown, each activity 165 is displayed in a graphical representation, labeled as 310a, 310b, and 310c. A graphical representation 310a displays information related to an activity 165 on Friday from 8 pm to 10 pm. A graphical representation 310b displays information related to an activity 165 on Friday from 10 pm to 2 am. A graphical representation 310c displays information related to an activity 165 on Saturday from 10 am-12 pm.

As shown, each of the graphical representations includes a description of the represented activity 165, an average review received for the represented activity 165, and links through which the user can either accept or reject the proposed activity 165. Other information can be included in the activity 165. A window 305 includes instructions for the user to consider the activities 165 represented by the graphical representations.

In the example shown, graphical representations of only three activities 165 are shown in the user interface 300 because the client device 110 is a smart phone. As described above, the presentation engine 240 considers the type of client device 110 that will display the graphical representations when providing the activity sequence 245. The user may view graphical representations for additional activities 165 of the activity sequence 245 by scrolling or moving some of the displayed graphical representations out of the user interface 300.

After the user has considered the activities 165 corresponding to the graphical representations, the user may determine that they do not wish to perform the activity 165 corresponding to the graphical representation 310b. Accordingly, the user may have provided an indication of a rejection to the user interface 300 by selecting or touching the link labeled “Pick Another Activity” in the graphical representation 310b.

In response to the indication of selection the presentation engine 240 may select a substitute activity 165 from the ranked activities 235. The selected substitute activity 165 may have a start time and/or an end time that is similar to the rejected activity 165.

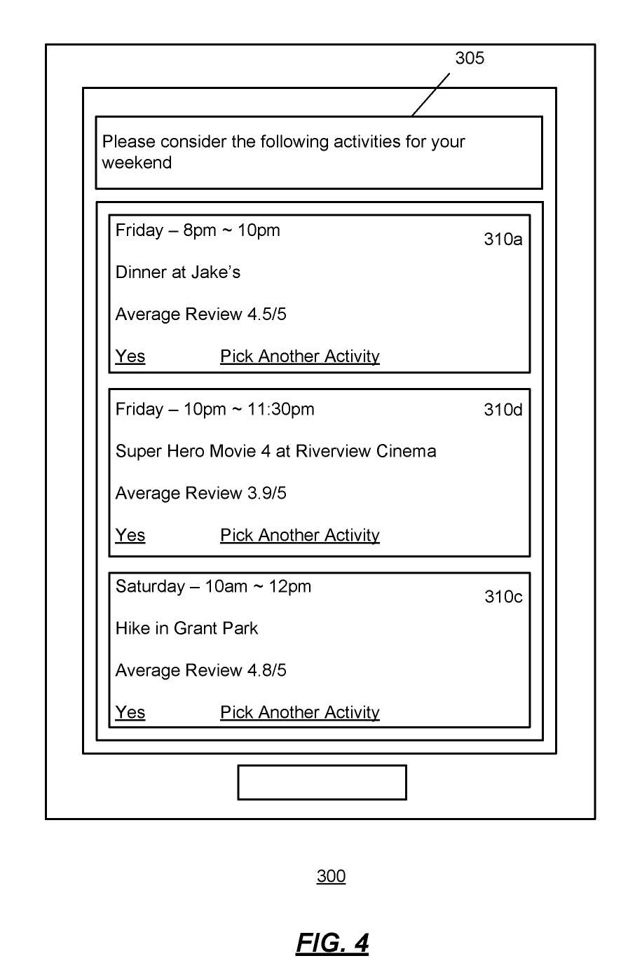

Continuing the example above, FIG. 4 is an illustration the user interface 300 that has been updated to reflect the substitute activity 165. In place of the graphical representation 310b, a new graphical representation 310d is displayed corresponding to the substitute activity 165. The user may accept or reject the substitute activity 165 as described above.

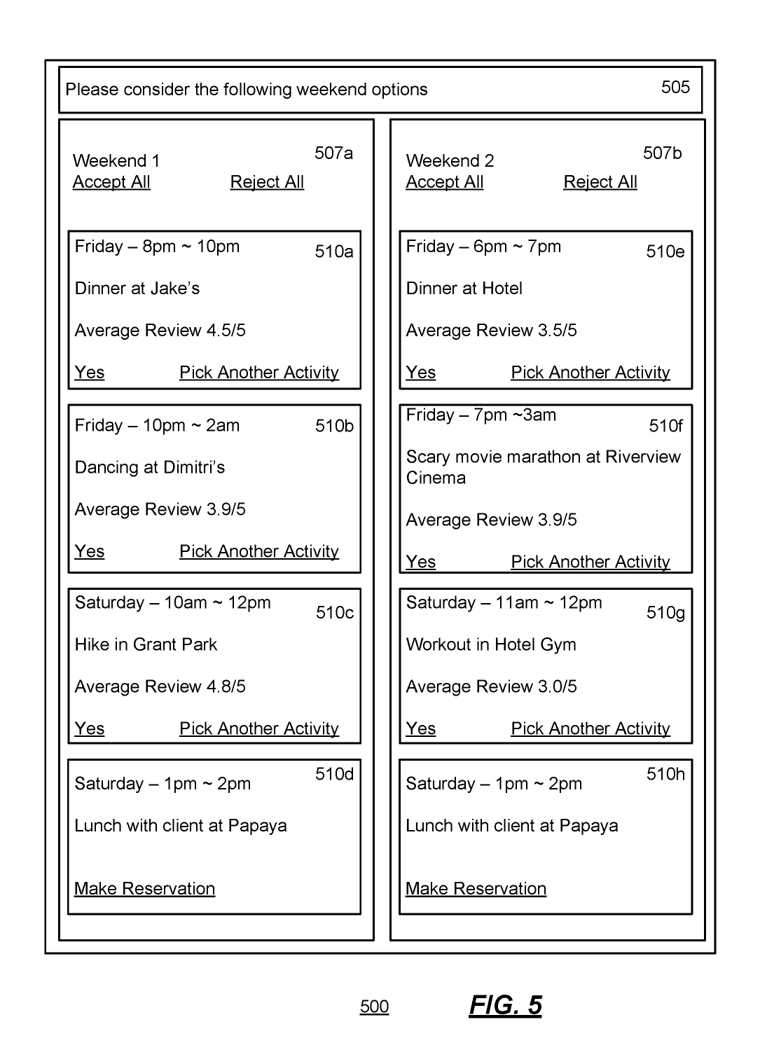

FIG. 5 is an illustration of an exemplary user interface 500 for presenting graphical representations of activities 165 to a user. As shown, the user interface 500 is larger than the user interface 300, and may be suitable for a client device 110 such as a tablet computer.

Because of the larger display size, the user interface 500 may display multiple (e.g., two) separate proposed activity sequences 245. A region 507a displays graphical representations 510a, 510b, 510c, and 510d of activities 165 corresponding to the proposed “weekend 1”, and a region 507b displays graphical representations 510e, 510f, 510g, and 510h of activities 165 corresponding to the proposed “weekend 2.” Accordingly, the user interface 500 includes a window 505 instructing the user to consider the different weekend options.

Similarly as in the user interface 300, the user may accept or reject any of the proposed activities 165 by selecting or touching the links marked “Yes” or “Pick Another Activity” in the corresponding graphical representation. In addition, the user is further able to accept or reject all of the activities 165 associated with the weekend 1 or the weekend 2 by selecting or touching the links marked “Accept All” or “Reject All” in the corresponding region 507.

As described above, when selecting the activities 165 for the activity sequence 245, the presentation engine 240 may consider activities 165 that are already scheduled within the start and end times associated with the activity sequence 245. Accordingly, both the weekend 1 and weekend 2 both respectively include graphical representations 510d and 510h that represent the same activity 165. As shown, the represented activity 165 corresponds to “Lunch with client at Papaya”, and may have been found in the calendar data 223 associated with the user. Accordingly, the presentation engine 240 has included the activity 165 in the activity sequences 245 corresponding to the weekend 1 and the weekend 2.

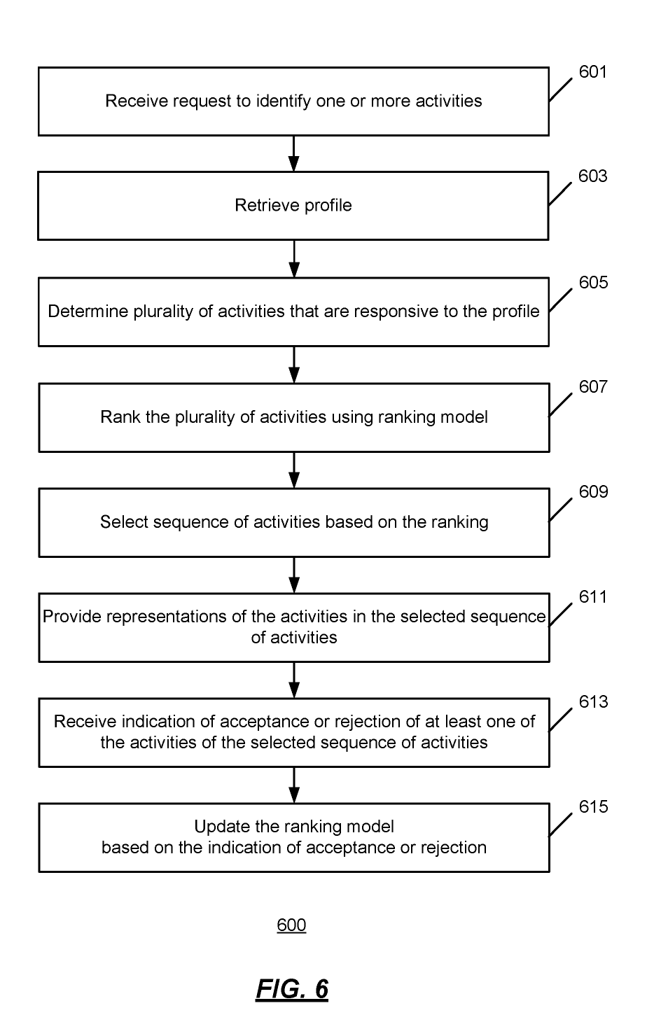

FIG. 6 is an operational flow of an implementation of a method 600 for selecting and displaying graphical representations of a sequence of activities. The method 600 may be implemented by the activity engine 125 and/or the search engine 160.

At 601, a request to identify one or more activities is received. The request may be an activity request 145 and may include a user identifier, a start time, and an end time. The activity request 145 may also include a location. The activity request 145 may be received by the search engine 160 from a calendar application 115, or may be received from the schedule engine 210 of the activity engine 125 based on calendar data 223 associated with the user. The start time and end time may define a period of time such as a weekend.

For example, the schedule engine 210 may determine that a user has unscheduled time that starts and ends at the start time and end time associated with the activity request 145. The calendar application 115 may also determine that the user will be in San Diego for the weekend. In order to ensure the user has activities 165 to attend during the weekend, the schedule engine 210 may generate an activity request 145 and submit the activity request 145 to the search engine 160.

At 603, a profile is retrieved. The profile 135 may be retrieved by the search engine 160 using the user identifier of the activity request 145. Alternatively, the profile 135 may have been included in the activity request 145 by the schedule engine 210 before the activity request 145 was sent to the search engine 160.

The profile 135 may include a plurality of attributes that may describe the particular likes, dislikes, and interests of the user. The profile 135 may further include demographic information about the user such as age and income. Other information may be included in the profile 135. The attributes of the profile 135 may be provided by the user, or may have been determined based on user behavior (e.g., pursuant to user consent), for example.

At 605, a plurality of activities that are responsive to the profile is determined. The plurality of activities 165 may be determined by the search engine 160 by identifying activities 165 from the search corpus 167 that match, or are partial matches of, the profile 135, and that have start and end times that fall within (i.e., between) the start and end times associated with the activity request 145. Depending on the implementation, an activity 165 may match a profile 135 when some or all of the attributes associated with the activity 165 match a corresponding attribute from the profile 135. Other methods for matching activities 165 with profiles 135 may be used.

At 607, the plurality of activities are ranked using a ranking model. The plurality of activities 165 may be ranked to generate the ranked activities 235 by the ranking engine 230 of the activity engine 125 using a ranking model 225. The ranking model 225 may be a model generated using machine learning from various data that has been collected about the user by a client device 110 associated with the user. This data may include calendar data 223, application data 222, and location data 221 collected by the client device 110. The ranking model 225 may have been further generated and/or adjusted based on previously recommended activities 165, and whether or not the user accepted or rejected those recommended activities 165.

At 609, a sequence of activities is selected based on the ranking. The activity sequence 245 may be an ordered sequence of activities 165 based on the start times and end times associated with each activity 165 in the activity sequence 245. The activity sequence 245 may be selected by the presentation engine 240 according to the ranking of each activity 165 in the ranked activities 235. Other information may also be considered when selecting the activities 165 for the activity sequence 245 such as historical traffic information, public transportation schedules, weather forecasts, and user preferences, for example.

At 611, representations of the activities in the selected sequence of activities are provided. The representations may be graphical representations and may be provided by displaying the graphical representations. The graphical representations may be displayed by the presentation engine 240 of the activity engine 125 based on device data 226 associated with the user. The device data 226 may describe the type and capabilities of the client device 110 that the user may use to view the activities 165 of the activity sequence 245. Each graphical representation may include a brief description of the activity 165 that it represents, along with user interface elements through which the user can either accept or reject the particular activity 165.

At 613, an indication of an acceptance or a rejection of at least one of the activities in the selected sequence of activities is received. The indication of an acceptance or a rejection of the at least one activity 165 may be received by the presentation engine 240 from the client device 110. For example, the user may have selected or touched the user interface element associated with the graphical representation of the at least one activity of the plurality of activities 165 that corresponds to either accepting or rejecting the activity.

At 615, the ranking model is updated based on the indication of an acceptance or a rejection. The ranking model 225 may be updated using machine learning by the model engine 220 of the activity engine 125. Where the indication was an indication of an acceptance, the presentation engine 240 may also select a substitute activity from the ranked activities 235, and may display a graphical representation of the substitute activity in place of the graphical representation of the at least one activity. The substitute activity may have a start time and an end time that is similar to the start time and end time of the at least one activity.

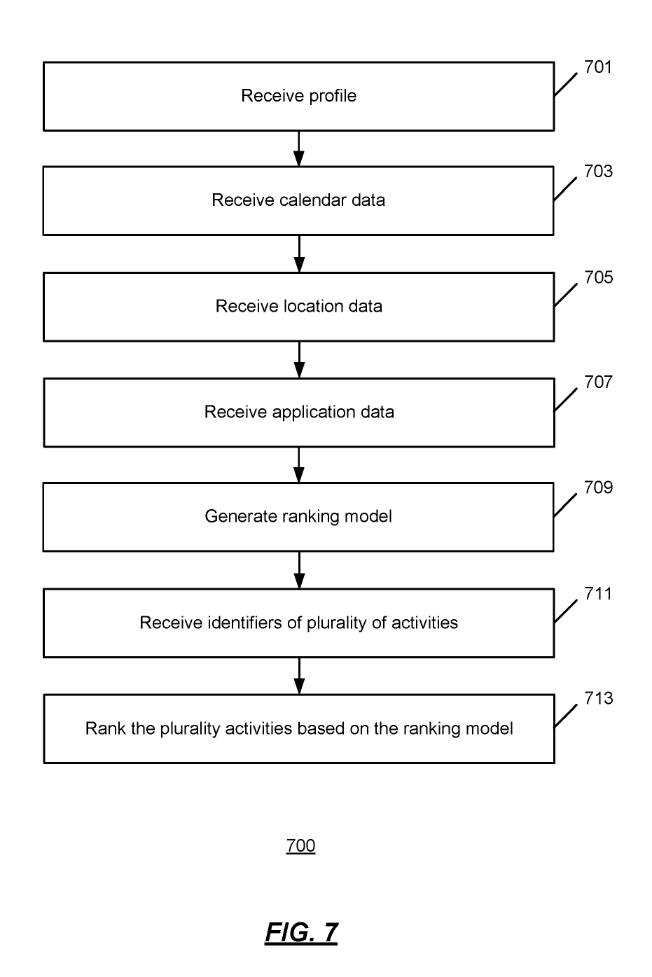

FIG. 7 is an operational flow of an implementation of a method 700 for generating a ranking model and ranking a plurality of activities using the ranking model. The method 700 may be implemented by the activity engine 125.

At 701, a profile is received. The profile 135 may be received by the model engine 220 of the activity engine 125. The profile 135 may include a plurality of attributes that were entered by a user associated with the profile 135. The attributes may describe the interests of the user, and may include demographic information about the user.

At 703, calendar data is received. The calendar data 223 may be received by the model engine 220 of the activity engine 125 from one or more calendar applications 115 associated with the user of the client device 110. The calendar data 223 may include information related to the activities 165 that the user has attended or performed in the past, as well as information related to the activities 165 that the user declined.

At 705, location data is received. The location data 221 may be received by the model engine 220 of the activity engine 125. The location data 221 may include a location history for the client device 110 associated with the user. The various locations of the client device 110 over time may be used by the model engine 220 to infer a variety of information about the user such as the types of restaurants the user frequents, the activity level of the user, the types of films and music that the user prefers, etc.

At 707, application data is received. The application data 222 may be received by the model engine 220 from one or more applications associated with the user of the client device 110. The application data 222 may include data received from applications such as social networking applications, productivity applications, and messaging applications.

At 709, a ranking model is generated. The ranking model 225 may be generated by the model engine 220 of the activity engine 125 using the attributes from the profile 135, the calendar data 223, the location data 221, and the application data 222.

At 711, identifiers of a plurality of activities are received. The identifiers of a plurality of activities 165 may be received by the ranking engine 230 of the activity engine 125. Each identified activity 165 may have a plurality of attributes. The plurality of activities 165 may have been identified by a search engine 160 in response to an activity request 145, for example.

At 713, the plurality of activities are ranked based on the ranking model. The plurality of activities 165 may be ranked by the ranging engine 230 using the generated ranking model 225 and may be provided as the ranked activities 235. The presentation engine 240 may then select activities 165 from the ranked activities 235 to present to the user in response to the activity request 145.

FIG. 8 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 800. In its most basic configuration, computing device 800 typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

Computing device 800 may have additional features/functionality. For example, computing device 800 may include additional storage (removable and/or non-removable) including, but not limited to, magnetic or optical disks or tape. Such additional storage is illustrated in FIG. 8 by removable storage 808 and non-removable storage 810.

Computing device 800 typically includes a variety of computer readable media. Computer readable media can be any available media that can be accessed by the device 800 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 800.

Computing device 800 may contain communication connection(s) 812 that allow the device to communicate with other devices. Computing device 800 may also have input device(s) 814 such as a keyboard, mouse, pen, voice input device, touch input device, etc. Output device(s) 816 such as a display, speakers, printer, etc. may also be included. All these devices are well known in the art and need not be discussed at length here.

In an implementation, a system for selecting activities based on a profile associated with a user identifier and for providing representations of the selected activities is provided. The system includes a computing device, and an activity engine. The activity engine is configured to: send a request to identify one or more activities to a search engine, wherein the request includes a user identifier and a profile, and wherein the profile is associated with a user identifier and comprises a plurality of attributes; receive a plurality of activities that are responsive to the profile based on the plurality of attributes of the profile and a plurality of attributes associated with each activity of the plurality of activities; rank the plurality of activities using a ranking model associated with the user identifier and the attributes associated with the activities of the plurality of activities; select a sequence of activities from the plurality of activities based on the ranking; and provide representations of the activities in the selected sequence of activities by the computing device.

Implementations may include some or all of the following features. The activity engine may be further configured to: receive an indication of an acceptance of at least one activity of the selected sequence of activities; and in response to the indication of an acceptance, add the at least one activity to a calendar associated with the user identifier. The activity engine may be further configured to, in response to the indication of an acceptance, update the ranking model. The activity engine may be further configured to: receive an indication of a rejection of at least one activity of the selected sequence of activities; and in response to the indication of a rejection, provide a representation of a substitute activity from the plurality of activities. The activity engine may be further configured to, in response to the indication of a rejection, update the ranking model. The request may further include a location and each activity of the plurality of activities may be associated with a location, and the activity engine configured to determine the plurality of activities that are responsive to the profile may further include the activity engine configured to determine the plurality of activities that are responsive to the profile based on the location of the request and the location associated with each activity of the plurality of activities. The location of the request may be one or more of entered by a user associated with the user identifier, determined by a location determination component of the computing device, or determined from a calendar associated with the user identifier.

In an implementation, a method for generating a ranking model for ranking activities associated with a user identifier using a profile, calendar data, location data, and application data associated with the user identifier is provided. The method includes: receiving a profile associated with a user identifier by a computing device; receiving calendar data associated with the user identifier by the computing device, the calendar data identifying an activity history associated with the user identifier; receiving location data associated with the user by the computing device, the location data identifying a plurality of locations associated with the user identifier; receiving application data associated with the user by the computing device, the application data comprising data from a plurality of applications associated with the user identifier; generating a ranking model for the user identifier based on the profile, the calendar data, the location data, and the application data by the computing device; receiving identifiers of a plurality of activities by the computing device; and ranking the activities of the plurality of activities based on the ranking model by the computing device.

Implementations may include some or all of the following features. The method may further include receiving indicators of acceptance and indicators of rejection with respect to each of the activities of the plurality of activities, and updating the ranking model based on the received indicators of acceptance and the received indicators of rejection. The activity history may include data identifying activities attended by a user associated with the user identifier and activities not attended by the user associated with the user identifier. The location data may be collected by a mobile device associated with the user identifier. The application data may include a search history of a user associated with the user identifier.

In an implementation, a method for selecting activities based on a profile associated with a user identifier and for providing representations of the selected activities on a is provided. The method includes: receiving a request to identify one or more activities by a computing device, wherein the request includes a user identifier; retrieving a profile associated with the user identifier by the computing device, wherein the profile comprises a plurality of attributes; determining a plurality of activities that are responsive to the profile based on the plurality of attributes of the profile and a plurality of attributes associated with each activity of the plurality of activities by the computing device; ranking the plurality of activities using a ranking model associated with the user identifier and the attributes associated with each activity of the plurality of activities by the computing device; selecting a sequence of activities from the plurality of activities based on the ranking by the computing device, wherein the sequence of activities is ordered based on times associated with each activity in the sequence of activities; and providing representations of the activities in the selected sequence of activities by the computing device.

Implementations may include some or all of the following features. The method may further include receiving an indication of an acceptance of at least one activity of the selected sequence of activities, and in response to the indication of an acceptance, adding the at least one activity to a calendar associated with the user identifier. The method may further include, in response to the indication of an acceptance, updating the ranking model. The method may further include receiving an indication of a rejection of at least one activity of the selected sequence of activities, and in response to the indication of a rejection, providing a representation of a substitute activity from the plurality of activities. The method may further include, in response to the indication of a rejection, updating the ranking model. The request may further include a location and each activity of the plurality of activities may be associated with a location, and determining the plurality of activities that are responsive to the profile may further include determining the plurality of activities that are responsive to the profile based on the location of the request and the location associated with each activity of the plurality of activities. The location of the request may be one or more of entered by a user associated with the user identifier, determined by a location determination component of the computing device, or determined from a calendar associated with the user identifier. The request may be received in response to a determination that an amount of unallocated time in a calendar associated with the user identifier exceeds a threshold.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for selecting activities based on a profile associated with a user identifier and for providing representations of the selected activities comprising:
a computing device
an activity engine configured to:
send a request to identify one or more activities to a search engine, wherein the request includes a user identifier and a profile, and wherein the profile is associated with a user identifier and comprises a plurality of attributes;
receive a plurality of activities that are responsive to the profile based on the plurality of attributes of the profile and a plurality of attributes associated with each activity of the plurality of activities;
rank the plurality of activities using a ranking model associated with the user identifier and the attributes associated with the activities of the plurality of activities;
select a sequence of activities from the plurality of activities based on the ranking; and
provide representations of the activities in the selected sequence of activities by the computing device.

2. The system of claim 1, wherein the activity engine is further configured to:
receive an indication of an acceptance of at least one activity of the selected sequence of activities; and
in response to the indication of an acceptance, add the at least one activity to a calendar associated with the user identifier.

3. The system of claim 2, wherein the activity engine is further configured to, in response to the indication of an acceptance, update the ranking model.

4. The system of claim 1, wherein the activity engine is further configured to:
receive an indication of a rejection of at least one activity of the selected sequence of activities; and
in response to the indication of a rejection, provide a representation of a substitute activity from the plurality of activities.

5. The system of claim 4, wherein the activity engine is further configured to, in response to the indication of a rejection, update the ranking model.

6. The system of claim 1, wherein the request further comprises a location and each activity of the plurality of activities is associated with a location, and the activity engine configured to determine the plurality of activities that are responsive to the profile further comprises the activity engine configured to determine the plurality of activities that are responsive to the profile based on the location of the request and the location associated with each activity of the plurality of activities.

7. The system of claim 6, wherein the location of the request is one or more of entered by a user associated with the user identifier, determined by a location determination component of the computing device, or determined from a calendar associated with the user identifier.

8. A method for generating a ranking model for ranking activities associated with a user identifier using a profile, calendar data, location data, and application data associated with the user identifier, comprising:
receiving a profile associated with a user identifier by a computing device;
receiving calendar data associated with the user identifier by the computing device, the calendar data identifying an activity history associated with the user identifier;
receiving location data associated with the user by the computing device, the location data identifying a plurality of locations associated with the user identifier;
receiving application data associated with the user by the computing device, the application data comprising data from a plurality of applications associated with the user identifier;
generating a ranking model for the user identifier based on the profile, the calendar data, the location data, and the application data by the computing device;
receiving identifiers of a plurality of activities by the computing device; and
ranking the activities of the plurality of activities based on the ranking model by the computing device.

9. The method of claim 8, further comprising receiving an indicator of an acceptance of at least one of the activities of the plurality of activities, and updating the ranking model based on the received indicator of an acceptance.

10. The method of claim 8, wherein the activity history comprises data identifying activities attended by a user associated with the user identifier and activities not attended by the user associated with the user identifier.

11. The method of claim 8, wherein the location data is collected by a mobile device associated with the user identifier.

12. The method of claim 8, wherein the application data comprises a search history of a user associated with the user identifier.

13. A method for selecting activities based on a profile associated with a user identifier and for providing graphical representation of the selected activities on a display associated with the user identifier comprising:
receiving a request to identify one or more activities by a computing device, wherein the request includes a user identifier;
retrieving a profile associated with the user identifier by the computing device, wherein the profile comprises a plurality of attributes;
determining a plurality of activities that are responsive to the profile based on the plurality of attributes of the profile and a plurality of attributes associated with each activity of the plurality of activities by the computing device;
ranking the plurality of activities using a ranking model associated with the user identifier and the attributes associated with each activity of the plurality of activities by the computing device;
selecting a sequence of activities from the plurality of activities based on the ranking by the computing device, wherein the sequence of activities is ordered based on times associated with each activity in the sequence of activities; and
providing representations of the activities in the selected sequence of activities by the computing device.

14. The method of claim 13, further comprising:
receiving an indication of an acceptance of at least one activity of the selected sequence of activities; and
in response to the indication of an acceptance, adding the at least one activity to a calendar associated with the user identifier.

15. The method of claim 14, further comprising, in response to the indication of an acceptance, updating the ranking model.

16. The method of claim 13, further comprising:
receiving an indication of a rejection of at least one activity of the selected sequence of activities; and
in response to the indication of a rejection, providing a representation of a substitute activity from the plurality of activities.

17. The method of claim 16, further comprising, in response to the indication of a rejection, updating the ranking model.

18. The method of claim 13, wherein the request further comprises a location and each activity of the plurality of activities is associated with a location, and determining the plurality of activities that are responsive to the profile further comprises determining the plurality of activities that are responsive to the profile based on the location of the request and the location associated with each activity of the plurality of activities.

19. The method of claim 18, wherein the location of the request is one or more of entered by a user associated with the user identifier, determined by a location determination component of the computing device, or determined from a calendar associated with the user identifier.

20. The method of claim 13, wherein the request is received in response to a determination that an amount of unallocated time in a calendar associated with the user identifier exceeds a threshold.
